(19) United States
(12) Patent Application Publication
(10) Pub. No.: US 2012/0106904 A1
(43) Pub. Date: May 3, 2012

(54) MOLDING OF OPTICAL CONNECTORS USING A CORE PIN

(75) Inventors: William Lamar Herb, Harrisburg, PA (US); Robert Nelson Fair, JR., York, PA (US); Doanld Eugene Dellinger, Hellan, PA (US)

(73) Assignee: Tyco Electronics Corporation, Berwyn, PA (US)

(21) Appl. No.: 12/917,742

(22) Filed: Nov. 2, 2010

(51) Int. Cl. G02B 6/42; G02B 6/26; B28B 7/28

(52) U.S. Cl. 385/93; 249/177; 264/1.25

(57) ABSTRACT

A core pin assembly is provided that includes a core pin insert comprising a core pin body and at least one pin member, and a core pin support defining a passageway for receiving the core pin member. The core pin support, when assembled to the core pin insert, retains the core pin members in desired positions and resists unintended flexing of the core pin members during the molding process. When used to create a lens body, the presence of the core pin support in the mold during the molding process causes formation of a void, or “window,” in the molded lens body. The window of the lens body may be used to advantage in fixing optical fibers to the lens body by applying epoxy within the window directly to the fiber's glass core/cladding, and in close physical proximity to the fibers distal end within the lens body's passageway.

### FIELD OF INVENTION

The present invention relates generally to optical connectors, and more particularly to a method and apparatus for manufacturing molded optical connectors using a core pin.

### BACKGROUND

Fiber optic connectors of various types are found in virtually all fiber optic communication systems. For example, such optical connectors may be used to join segments of fibers and to connect fiber to active and passive devices. To ensure proper optical coupling, each connector must maintain at least one fiber end in an aligned position, such that the core of the fiber is axially aligned with the core of the other fiber; etc. This is a particularly challenging task because the light-carrying region (glass core) of an optical fiber is quite small, e.g., approximately 8 microns for single mode fibers. The effectiveness of the optical connection depends upon the precision of the alignment of fibers and/or other optical components. If such fiber optic elements are not precisely aligned with one another, a resulting loss of signal will impair the effectiveness of the connection.

Various types of optical connectors are well-known in the art. Exemplary connectors include FC, LC, MT-RJ, and MPO style connectors. Typically, such connectors include a fiber-receiving opening that extends lengthwise along the connector. Depending upon the context, such an opening is often referred to as a “passageway” or “bore,” herein collectively referred to as a “passageway.” The passageway must be precisely positioned relative to the connector to ensure proper axial alignment.

Such passageways can be formed in a variety of ways. A common method involved forming a connector body by injecting molten plastic material into a closed mold as part of an injection molding process. In such a context, a core pin is often used as an insert to the mold. As is known in the art, such a core pin is positioned in the mold, and plastic material is molded around the core pin during a molding operation to form the desired connector body. After molding, the core pin is removed from the molded body, such that optical fibers may be inserted into the passageways/bores formed by the core pin. The core pin is typically constructed of steel, and may include one or more core pin members.

By way of example, the optical connector may be a lens body suitable for inclusion in a transceiver for coupling an optical fiber to an optoelectronic device. An exemplary lens body has a unitary body constructed of an optically-clear moldable material. The term “optically-clear moldable material” as used herein means characterized by low losses in the transmission of an optical signal. For example, the lens body may be uniformly formed by molding fluent plastic material into a precisely-defined shape and configuration such that all of the optical path elements are set, e.g. by injection molding, compression molding or transfer molding a polycarbonate, polyetherimide or polyethersulfone material, such as those commercially available from General Electric Corporation as ULTEM™ or RADEL™. FIG. 1 is a perspective view of a core pin insert 10 exemplary of the prior art that may be inserted into a mold as part of a molding process to produce the exemplary lens body 50 of the prior art. The core pin insert 10 is exemplary in that it includes at least one core pin member 12 around which plastic material will be molded to form a passageway for an optical fiber. The lens body 50 is exemplary in that it includes at least one passageway 52 defined by the core pin member 12 during the molding of the lens body 50, as best shown in FIGS. 2 and 3.

The lens body 50 is further exemplary of certain typical lens bodies in that it includes a bottom surface 54 for abutting a substrate supporting one or more OEDs (such as VCSELs), a lens 56 corresponding to each passageway 52 for focusing light onto the OED and/or a distal end of the fiber in the passageway 52, and a reflective surface 58 for reflecting light transmitted between the OEDs and the optical fiber(s) in the passageway(s). Where the direction of light propagation is reversed, the fiber is the light source and light is coupled from the fiber to a receiving photodiode through the lens. Thus, the lens body 50 provides an optical path between each OED on the substrate and each optical fiber supported in a passageway 52, and thus is suitable for optically coupling the OED(s) and the optical fiber(s).

It is thus important that the passageway 52, and particularly each passageway's distal end 60 (formed by a distal end 14 of a core pin member 12) be precisely aligned within the body 52 relative to the reflective surface 58 and the lens 56. An exemplary pin member has a proximal section having a cylindrical cross-section measuring approximately 250 microns (for supporting an optical fiber including a buffer and jacket), and a distal section having a cylindrical cross-section measuring approximately 125 microns (for supporting a portion of fiber stripped of its buffer and jacket). Accordingly, the core pin members are extremely slender, and thus susceptible to flexing that results in deviation from intended positions of the core pin members. It is believed that such flexing is due primarily to forces exerted by the molten plastic introduced under pressure into the mold during the molding process. Such flexing results in deviation from intended positions of the resulting passageways, which in turn causes misalignment of the optical fibers in a finished assembly. Such misalignment is undesirable because it decreases optical performance, as discussed above. Such misalignment is particularly insidious because it is often detected only during active testing, after molding and after assembly of the molded connector into a transceiver or other more complex optical assembly, at which point a significant investment may already have been made in a defective optical component.

What is needed, and what the prior art appears to be lacking, is a method and apparatus for manufacturing an optical connector that reduces or avoids such flexing of the core pin, and thus promotes accurate position of the passageways, and thus improves optical performance of the molded connector and/or an optical assembly including the connector. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

One aspect of the present invention provides a core pin assembly. The core pin assembly includes a core pin insert comprising a core pin body and at least one axially-elongated core pin member supported on and extending from the core pin body. The core pin assembly further includes a core pin support comprising a rigid body member defining an axially-extending passageway dimensioned to receive the core pin member. The core pin support, when assembled to the core pin insert, retains the core pin members in desired positions and resists unintended flexing of the core pin members during the molding process. Another aspect of the present invention provides a method for manufacturing an optical connector having an axial passageway. The method involves providing such a core pin assembly, providing a molding apparatus comprising mold members configured to cooperate with the core pin assembly to define a mold cavity for molding the optical connector, preparing the mold cavity by assembling the core pin assembly to the mold members and closing the mold members, introducing moldable material into the mold cavity and around at least portions of the core pin member and the core pin support, and opening the mold members and withdrawing the optical connector from the mold cavity.

Yet another aspect of the present invention provides a windowed lens body. The presence of the core pin support in the mold during the molding process causes formation of a void, or “window,” in the molded lens body. The window of the lens body may be used to advantage in fixing optical fibers to the lens body by applying epoxy within the window directly to the fiber's glass core/cladding, and in close physical proximity to the fibers distal end within the lens body's passageway.

Still another aspect of the present invention provides a method for manufacturing an optical subassembly. This method involves providing an optical fiber comprising a glass fiber core, cladding bonded to the glass fiber core, a buffer surrounding said cladding, and a jacket surrounding said buffer. The method further involves providing a lens body of an optically-clear moldable material comprising a lens adapted to focus light along an optical path between an optoelectronic device and an optical fiber, a reflective surface disposed to alter a direction of the optical path and a passageway for supporting at least one optical fiber in alignment with said reflective surface and said lens, said passageway being discontinuous and having a distal end adjacent said reflective surface and a proximal end opposite said distal end, said distal end being separated from said proximal end by a window defined by said lens body. The method further involves cleaving the optical fiber to remove a portion of the buffer and jacket to expose a portion of the clad glass fiber core, positioning the cleaved optical fiber through the proximal and distal ends of the passageway of the lens body with a portion of the exposed clad glass fiber core positioned within the window of the lens body, and applying bonding material within the window to bond the lens body directly to the exposed clad glass fiber core.

### BRIEF SUMMARY OF DRAWINGS

The present invention will now be described by way of example with reference to the following drawings in which:

FIG. 1 is a perspective view of a core pin insert exemplary of the prior art;

FIG. 2 is a top view of a lens body exemplary of the prior art;

FIG. 3 is a cross-sectional view of the lens body of FIG. 2, taken along line A-A of FIG. 2;

FIG. 4 is a perspective view of a core pin assembly including a core pin support in accordance with an exemplary embodiment of the present invention;

FIG. 5 is a top view of a windowed lens body in accordance with an exemplary embodiment of the present invention;

FIG. 6 is a cross-sectional view of the windowed lens body of FIG. 5, taken along line A′-A′ of FIG. 5;

FIG. 7 is an exploded perspective view showing the relationship between the core pin assembly of FIG. 4 and the windowed lens body of FIG. 5; and

FIG. 8 is a cross-sectional view of the windowed lens body of FIG. 5, taken along line A′-A′ of FIG. 5, and showing adhesive bonding to exposed glass fiber within the window.

### DETAILED DESCRIPTION

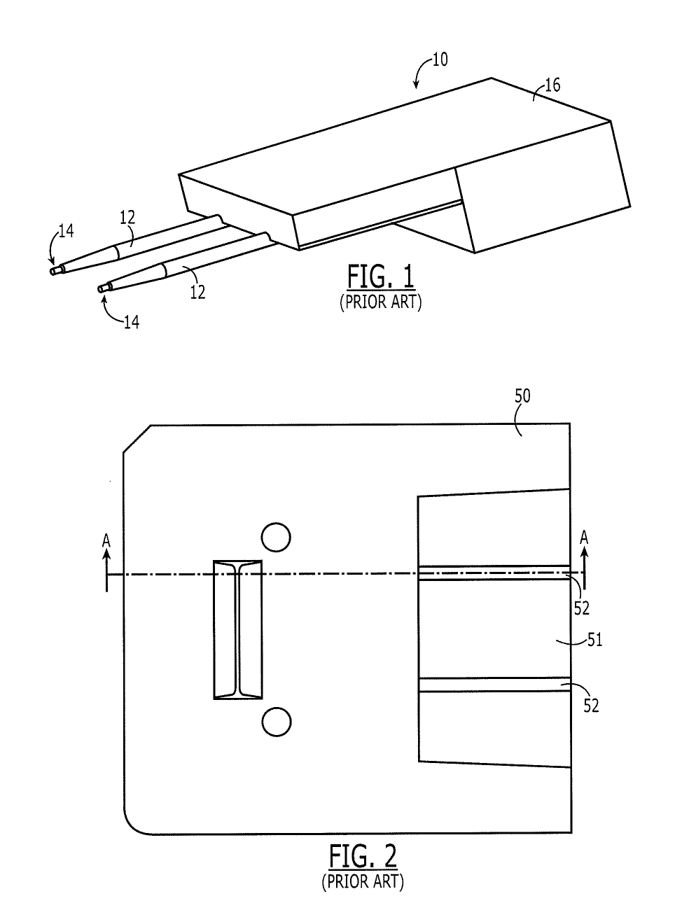

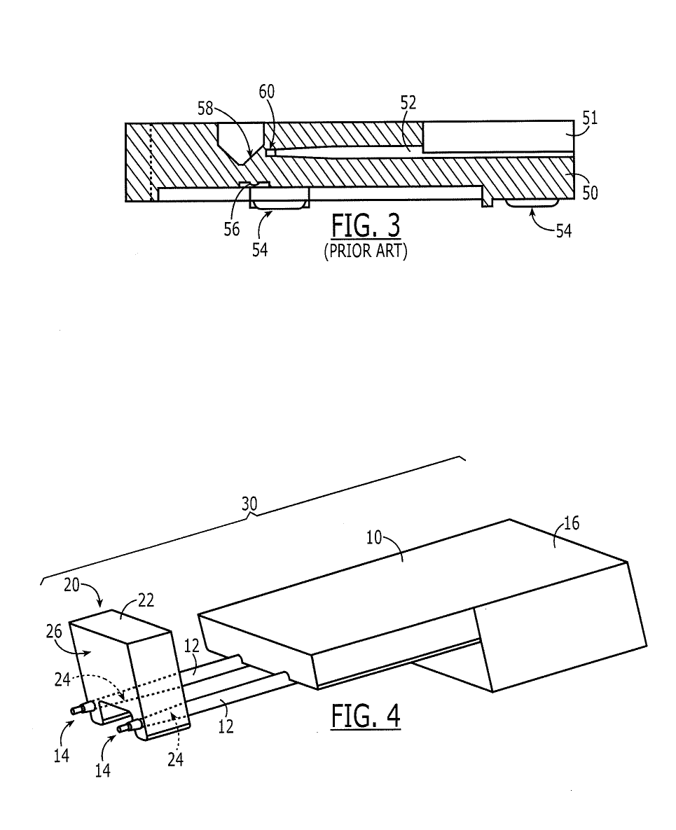

Although the present invention is applicable to a broad range of fiber optic connectors formed by molding using core pins such as MT, MT-RJ, MPO, MPX, MU style connectors, the present invention is discussed below in the context of a lens body for illustrative purposes. As discussed above, FIGS. 2 and 3 show an exemplary lens body 50 molding using an exemplary core pin insert 10 (FIG. 1) including exemplary core pin members 12.

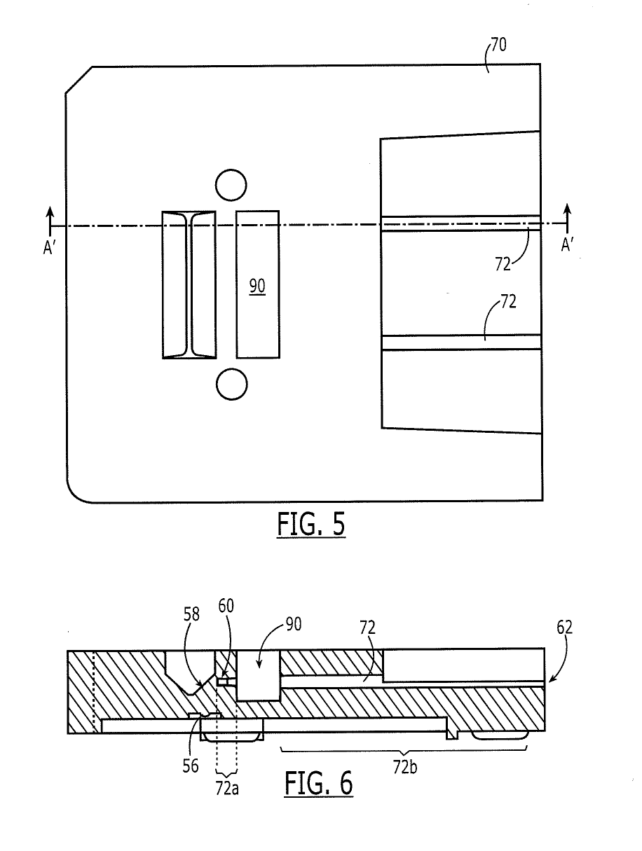

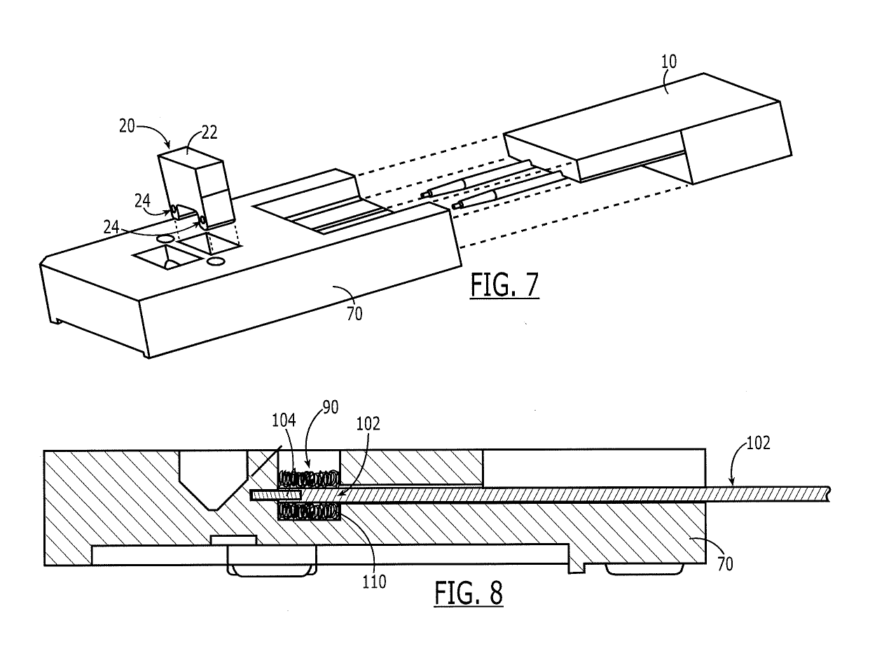

FIG. 4 is a perspective view of a core pin assembly 30 including a core pin support 20 in accordance with an exemplary embodiment of the present invention. The core pin assembly 30 may be used in a substantially conventional molding process to produce a lens body, such as a windowed lens body 70 in accordance with an exemplary embodiment of the present invention shown in FIGS. 5 and 6. The exemplary windowed lens body 70 is substantially similar to a conventional lens body 50 in that it includes passageways 72 formed by the core pin members 12, a lens 56, a reflective surface 58, etc. However, unlike a conventional lens body 50, the windowed lens body 70 further includes a void, or “window” 90, created by the presence of the core pin support 20 of the core pin assembly in the mold during molding of the windowed lens body 70. A relationship between the core pin insert 10, core pin support 20 and windowed lens body 70 is shown in the exploded perspective view of FIG. 7. The window 90 is to some extent a by-product resulting from the primary purpose of the core pin support 20 as supporting the distal ends 14 (free ends) of the core pins in the region of the distal ends 60 of the passageways. However, in accordance with the present invention, the window 90 of the windowed lens body 70 may be used to advantage in fixing optical fibers to the lens body 70, as discussed in greater detail below with reference to FIG. 8.

Referring now to FIG. 4 the core pin assembly 30 is discussed in greater detail. As referenced above, the core pin assembly 30 includes a conventional core pin insert 10. As is typical of conventional core pin inserts, exemplary core pin insert 10 includes a core pin body 16 and at least one axially-elongated core pin member 12 supported on and extending from the core pin body 16. One end of each core pin member 12 is attached to the core pin body. The opposite end (distal end 14) of each core pin member 12 is a free end. As is conventional, the core pin insert 10 is constructed of a rigid material, e.g., steel.

In accordance with the present invention, the core pin assembly 30 further includes a core pin support 20. The core pin support includes a rigid body member 22 defining a respective axially-extending passageway 24 for receiving each core pin, as best shown in FIG. 7. By way of example, the core pin support 20 may be constructed of steel, e.g., by a machining process. For a core pin insert 10 including multiple axially-elongated core pin members 12, the passageways 24 are arranged in a spaced relationship corresponding to a spaced relationship of the core pin members 12, as best shown in FIG. 7.

The passageways 24 maybe be formed in the body in any suitable manner, e.g., by a machining process, and are dimensioned to receive, support and retain the pin member members 12 in a predetermined, and intended, spatial relationship, e.g., parallel or substantially parallel to a reference datum along the length of the core pin members 12. Close tolerances between the outside dimension(s) of the core pin member 12 and the inside dimension(s) of the passageway 24 are preferred to ensure proper positioning of the distal ends 14 of the core pin members. For example, for a core pin member 12 having a maximum diameter measuring 250 microns, a passageway 24 having a maximum diameter measuring approximately 300 microns may be suitable. For example, the passageway may be tapered from approximately 300 microns at one end to approximately 195 microns at the opposite end.

The core pin assembly 30 may be used in a substantially conventional molding process to produce a lens body or other connector. The core pin assembly may be positioned in the mold using conventional techniques. When in final position in the mold, the core pin assembly is arranged with the core pin members 12 of the core pin insert 10 extending through the core pin support's passageways 24, as shown in FIG. 4. In this manner, and/or by otherwise fixing the core pin insert 10 and core pin support 20 to a common rigid member, the core pin support 20 is fixed in position relative to the core pin insert 10 such that the core pin member and the support's passageway extend along a common axis.

Preferably, the core pin support 20 is positioned relatively close to the distal ends (free ends) 14 (see FIG. 4) of the core pin members 12 to provide adequate support to the core pin members, and retain them in their desired positions, during molding of the connector, e.g., as fluent plastic material is introduced into the mold (not shown) for forming the connector. Further, by positioning the core pin support 20 such that the core pin members 12 extend beyond a face 26 of the support 20 (as shown in FIG. 4), portions 72a, 72b of the passageway 72 are formed on both the proximal and distal sides of the core pin support 20, such that the fiber will be physically supported by the lens body 70 on both sides of the window 90 formed by the core pin support 20, as best shown in FIG. 6. This arrangement promotes proper positioning of the distal end of the fiber, in the distal end of the passageway 60, relative to the connector/lens body 70.

The molding process may be conducted in a substantially conventional manner. Accordingly, a molding apparatus may be provided that includes mold members configured to cooperate with the core pin assembly to define a mold cavity formed by the optical connector. The mold cavity may then be supported by assembling the core pin assembly to the mold members and closing the mold members. Such assembly includes assembly of the core pin support to the core pin insert with the core pin member(s) extending through the passageway(s) of the core pin support. This step may further include fixing the core pin support and core pin member in relative positions in which the core pin member and the passageway extend along a common axis. After the connector has cured/cooled sufficiently, the mold members may be opened, and the core pin insert 10, core pin support 20, and molded optical connector may be withdrawn from the mold cavity. In accordance with the exemplary embodiment shown, the molded connector is a windowed lens body 70, as best shown in FIGS. 5-7. More specifically, the windowed lens body 70 includes a window 90 that is a void defined by the core pin support 20 between a proximal end 62 and a distal end 60 of the passageway(s) formed by the core pin members 12, as best shown in FIG. 6. Accordingly, the window 90 is positioned on the lens body 70 between distal portion 72a and proximal portion 72b of the passageway 72, as best shown in FIG. 6.

Referring now to FIG. 8, the window 90 may be used to advantage in fixing optical fibers 100 to the lens body 70 during manufacture of an optical subassembly, as referenced above. As is well-known in the art, such fibers include a glass fiber core surrounded by cladding, buffer and jacket layers (buffer and jacket collectively shown as 102 in FIG. 8). The buffer and jacket layers 102 are typically removed when the fiber is cleaved for termination or splicing (the cladding being bonded directly to the glass core), leaving exposed a portion of the glass core and cladding (the glass core and cladding collectively shown as 104 in FIG. 8). In a conventional lens body 50 (FIG. 2), each fiber is fixed to the lens body 50 by applying epoxy on the bonding shelf 51. Because the fiber's glass core 104 is not directly bonded to buffer and/or the jacket, applying epoxy directly to the jacket at the bonding shelf 51 is not preferred, as this creates ample opportunity for movement of the fiber within the buffer/jacket, and may promote misalignment of the fiber's distal end. As a result, fibers are often prepared to expose the glass core/cladding in the area of the shelf 51 to permit bonding directly to the core/cladding in the shelf area. However, the shelf area 51 is physically distant from the distal end 60 of the passageway 52/72, which permits an undesirable amount of movement of the distal end of the fiber even if epoxy is applied in the shelf area directly to the glass core.

To avoid these problems, the fiber 100 may be prepared to remove a portion of the buffer/jacket 102 and to expose a portion of the glass core/cladding 102 within the window 90, as shown in FIG. 8. Then, epoxy 110 may be applied directly o the glass core/cladding 102, and/or to the buffer/jacket 102, within the window. Because epoxy may be applied directly to the glass core/cladding 102, and because the epoxy is applied in close physical proximity (e.g., within approximately 0.5 mm to the distal end 60 of the passageway 72, the fiber 100's distal end is well-constrained, and proper alignment of the fiber 100 to an optical path is promoted.

Thus, an exemplary method for manufacturing an optical subassembly includes: providing an optical fiber comprising a glass fiber core, cladding bonded to the glass fiber core, a buffer surrounding said cladding, and a jacket surrounding said buffer; and providing a windowed lens body of an optically-clear moldable material. The windowed lens body includes a lens adapted to focus light along an optical path between an optoelectronic device and an optical fiber; a reflective surface disposed to alter a direction of the optical path; and a passageway for supporting at least one optical fiber in alignment with said reflective surface and said lens, said passageway being discontinuous and having a distal end adjacent said reflective surface and a proximal end opposite said distal end, said distal end being separated from said proximal end by a window defined by said lens body. The method further includes: cleaving the optical fiber to remove a portion of the buffer and jacket to expose a portion of the clad glass fiber core; positioning the cleaved optical fiber through the proximal and distal ends of the passageway of the lens body with a portion of the exposed clad glass fiber core positioned within the window of the lens body; and applying bonding material (e.g., epoxy) within the window to bond the lens body directly to the exposed clad glass fiber core.

While the present invention has been particularly shown and described with reference to the preferred mode as illustrated in the drawing, it will be understood by one skilled in the art that various changes in detail may be effected therein without departing from the spirit and scope of the invention as defined by the claims.

What is claimed is:

1. A core pin assembly comprising:
a core pin insert comprising:
a core pin body; and
at least one axially-elongated core pin member supported on and extending from said core pin body; and
a core pin support comprising a rigid body member defining an axially-extending passageway dimensioned to receive said core pin member.

2. The core pin assembly of claim 1, wherein said core pin insert comprises a plurality of axially-elongated core pin members supported on an extending from said core pin body in a spaced parallel relationship, and wherein rigid body member of said core pin support comprises a corresponding plurality of axially-extending passageways in a corresponding spaced parallel relationship, each of said corresponding plurality of axially-extending passageways being dimensioned to receive a respective one of said plurality of core pin members.

3. The core pin assembly of claim 1, wherein said core pin support is assembled to said core pin insert with said core pin member extending through said passageway of said core pin support.

4. The core pin assembly of claim 1, wherein said core pin support is fixed in position relative to said core pin insert such that said core pin member and said passageway extend along a common axis.

5. A method for manufacturing an optical connector having an axial passageway, the method comprising:
providing a core pin assembly comprising:
a core pin insert comprising a core pin body and at least one axially-elongated core pin member supported on and extending from said core pin body; and
a core pin support comprising a rigid body member defining an axially-extending passageway dimensioned to receive said core pin member;
providing a molding apparatus comprising mold members configured to cooperate with the core pin assembly to define a mold cavity for molding the optical connector;
preparing the mold cavity by assembling the core pin assembly to the mold members and closing the mold members;
introducing moldable material into the mold cavity and around at least portions of the core pin member and the core pin support; and
opening the mold members and withdrawing the optical connector from the mold cavity.

6. The method of claim 5, wherein preparing the mold cavity by assembling the core pin assembly to the mold members and closing the mold members comprises assembling the core pin support to the core pin insert with the core pin member extending through the passageway of the core pin support.

7. The method of claim 5, wherein preparing the mold cavity by assembling the core pin assembly to the mold members and closing the mold members comprises fixing the core pin support and the core pin member in relative positions in which the core pin member and the passageway extend along a common axis.

8. An optical connector for optically coupling an optoelectronic device with a corresponding optical fiber, connector comprising:
a lens body of an optically-clear moldable material comprising:
a lens adapted to focus light along an optical path between an optoelectronic device and an optical fiber;
a reflective surface disposed to alter a direction of the optical path;
a passageway for supporting at least one optical fiber in alignment with said reflective surface and said lens, said passageway being discontinuous and having a distal end adjacent said reflective surface and a proximal end opposite said distal end, said distal end being separated from said proximal end by a window defined by said lens body.

9. The optical connector of claim 8, wherein said optical fiber has a diameter measuring approximately 250 microns, and wherein said passageway has a maximum diameter measuring approximately 300 microns.

10. A method for manufacturing an optical subassembly, the method comprising:
providing an optical fiber comprising a glass fiber core, cladding bonded to the glass fiber core, a buffer surrounding said cladding, and a jacket surrounding said buffer;
providing a lens body of an optically-clear moldable material comprising:
a lens adapted to focus light along an optical path between an optoelectronic device and an optical fiber;
a reflective surface disposed to alter a direction of the optical path; and
a passageway for supporting at least one optical fiber in alignment with said reflective surface and said lens, said passageway being discontinuous and having a distal end adjacent said reflective surface and a proximal end opposite said distal end, said distal end being separated from said proximal end by a window defined by said lens body;
cleaving the optical fiber to remove a portion of the buffer and jacket to expose a portion of the clad glass fiber core;
positioning the cleaved optical fiber through the proximal and distal ends of the passageway of the lens body with a portion of the exposed clad glass fiber core positioned within the window of the lens body; and
applying bonding material within the window to bond the lens body directly to the exposed clad glass fiber core.

11. The method of claim 10, wherein providing a lens body of an optically-clear moldable material comprises:
providing a core pin assembly comprising:
a core pin insert comprising a core pin body and at least one axially-elongated core pin member supported on and extending from said core pin body; and
a core pin support comprising a rigid body member defining an axially-extending passageway dimensioned to receive said core pin member;
providing a molding apparatus comprising mold members configured to cooperate with the core pin assembly to define a mold cavity for molding the optical connector;
preparing the mold cavity by assembling the core pin assembly to the mold members and closing the mold members;
injecting moldable material into the mold cavity and around at least portions of the core pin member and the core pin support; and
opening the mold members and withdrawing the optical connector from the mold cavity.

12. The method of claim 11, wherein preparing the mold cavity by assembling the core pin assembly to the mold members and closing the mold members comprises assembling the core pin support to the core pin insert with the core pin member extending through the passageway of the core pin support.

13. The method of claim 11, wherein preparing the mold cavity by assembling the core pin assembly to the mold members and closing the mold members comprises fixing the core pin support and the core pin member in relative positions in which the core pin member and the passageway extend along a common axis.
